(19) United States
(12) Patent Application Publication
(10) Pub. No.: US 2009/0010472 A1
(43) Pub. Date: Jan. 8, 2009

(54) Acoustical grille free from spit moisture maintains frequency to keep realistic and natural sounds

(76) Inventor: Chin-Kuo Chiu, Taipei (TW)

Correspondence Address: SALLY CHANG, 7F, NO. 3, ALLEY 32, SEC. 6 CHUNG-HSIAO EAST RD., TAIPEI, TAIWAN, R.O.C. 115, TAIPEI, 115, TW

(21) Appl. No.: 11/822,044

(22) Filed: Jul. 2, 2007

(51) Int. Cl. H04R 19/04

(52) U.S. Cl. 381/369

(57) ABSTRACT

An acoustical grille (1) secured to a top of a receiver (50) of microphone (5) with an annular ring (10) free from spit moisture installed to a rim of the acoustical grille (1) with grille shells (11) shielded over the receiver (50); at least, a stand (2) connected between the annular ring (10) and positioning ring (3), whereby a distance kept between the grille shells (11) and the receiver (50). Grille shell (11) not only prevents spit in but low pitch, mid pitch, and high pitch sounds can be superimposed received into the receiver (50). Confused or harsh sound emissions of users or breath sounds can be absorbed between the grille shells (10), thereby sounds picked up by the microphone demands for a higher pitch, where the original sounds can be tuned within higher vocal compass. It may be played at soft volume; the sounds are mellow and expressive.

### FIELD OF THE INVENTION

The present invention relates to a slip-proof microphone free from spit moisture, particularly to a microphone maintains frequency response to keep realistic and natural sounds.

### DESCRIPTION OF THE PRIOR ARTS

As shown in FIG. 1, an exploded view of a conventional microphone is illustrated. A microphone cartridge (50b) mounted inside the microphone, opposite to the cartridge, the microphone is further surrounded by a grille shell (50a) from outside; therefore, the microphone (5) receiver (50) is free from sprayed by spit or dust. A windscreen (6) shell attached to an inner wall of the grille shell (50a), or the windscreen directly fit over an outer wall of grille shell (50a) thus avoid the microphone cartridge (50b) from malfunction or germ growth. Thereby, defects as mentioned above can be eliminated. Further confused or harsh sounds processed through them with better (phonetic) quality to maintains frequency response to keep true sound without aliasing. As well known, the most important pitches for speeches are 50-3000 Hz, however, low pitch, mid pitch, and high pitch sounds can be superimposed received into the microphone cartridge.

A windscreen (6) made of foam, or PU (polyurethane) foam, are easily to become humid, dusty, because there are chinks formed on the foam. Whereby sounds go off easily, after using for a longer while, an appearance of the windscreen may be spoiled by defects, easy to damage, even being out of shape. When a windscreen is produced, most of the foam must be hollowed out results in a large amount of foam deserted as a source of environmental pollution. Accordingly, the invention is to provide a microphone free from spit moisture, further to keep true sounds. In addition, a round tube like microphone put on the table, it is easy to slip away or fall off to the ground to be damaged due to a circumference of the round tube like microphone is substantially circular in shape. The present invention is to provide a microphone with, at least, a bump projected out the circumference of round tube like body as a slip-proof member.

### SUMMARY OF THE INVENTION

The present invention is to provide a slip-proof microphone free from spit moisture, further can be used to keep in harmony with realistic and natural sounds.

Point against aforesaid problems, there are two embodiments of such a microphone; the first embodiment is a microphone (5) equipped with an acoustical grille (1) free from spit moisture maintains frequency response to keep realistic and natural sounds, the acoustical grille (1) secured to a top of a receiver (50) of microphone (5) characterized in that: a positioning ring (3) fit around the receiver (50); an annular ring (10) free from spit moisture installed to a rim of the acoustical grille (1) with grille shells (11) shielded over the receiver (50); at least, a stand (2) connected between the annular ring (10) and positioning ring (3), whereby a distance kept between the grille shells (11) and the receiver (50).

A microphone (5) equipped with an acoustical grille (1) free from spit moisture maintains frequency response to, keep realistic and natural sounds as mentioned above wherein (1), an outer wall of the annular ring (10) is equipped with, at least, a bump (20) to prevent an annular ring (10) from slipping away.

A microphone (5) equipped with an acoustical grille (1) free from spit moisture maintains frequency response to keep realistic and natural sounds as mentioned above wherein the bump (20) is an extension of the stand (2) of the annular ring (10), the bump (20) extends in a direction is substantially perpendicular to an outer wall of the annular ring (10).

A microphone (5) equipped with an acoustical grille (1) free from spit moisture maintains frequency response to keep realistic and natural sounds as mentioned above wherein the positioning ring (3) has, at least, a crevice (30), a bolt assembly (4) adapted to be inserted through the crevice (30) to restrict a width of the crevice (30) to adjust tightness/looseness between the positioning ring (3) and the receiver (50).

A microphone (5) equipped with an acoustical grille (1) free from spit moisture maintains frequency response to keep realistic and natural sounds as mentioned above wherein the bolt assembly (4) consists of a first positioning bump (40) coupled to a first side of the crevice (30), a second positioning bump (41) coupled to a second side of the crevice (30), a threaded bolt (42) passed through the first positioning bump (40) then screwed to the second positioning bump (41).

A microphone (5) equipped with an acoustical grille (1) free from spit moisture maintains frequency response to keep realistic and natural sounds as mentioned above wherein two grille shells (11) installed to a top side and a bottom side of the annual ring (10) respectively, a distance kept between the two grille shells (11).

A second embodiment of the invention is realized by a microphone (5) equipped with an acoustical grille (1) free from spit moisture maintains frequency response to keep realistic and natural sounds, the acoustical grille (1) secured to a receiver (50) of the microphone (5), characterized in that: a positioning ring (3) secured to the receiver (50), an annular ring (10) shielded over a top of the receiver (50); a grille ring (12) with grille shells (11) inlaid in the annular ring (10); and, at least, a stand connected between the annular ring (10) and the positioning ring (3), a distance kept in between.

A microphone (5) equipped with an acoustical grille (1) free from spit moisture maintains frequency response to keep realistic and natural sounds as mentioned above wherein a number of grooves (101) formed around a perimeter of the annular ring (10) to facilitate fingers touch. A microphone (5) equipped with an acoustical grille (1) free from spit moisture maintains frequency response to keep realistic and natural sounds as mentioned above wherein slip-proof wrinkles (121) formed around the annular ring corresponding to the grooves (101).

A microphone (5) equipped with an acoustical grille (1) free from spit moisture maintains frequency response to keep realistic and natural sounds as mentioned above wherein two grille shells (11) installed to a top side and a bottom side of the grille ring (12), a distance kept between the two grille shells (11).

A microphone (5) equipped with an acoustical grille (1) free from spit moisture maintains frequency response to keep realistic and natural sounds as mentioned above wherein the positioning ring (3) has a crevice (30) and a threaded hole (21), the threaded hole (21) accommodates a screw (22) to screw therein.

A microphone (5) equipped with an acoustical grille (1) free from spit moisture maintains frequency response to keep realistic and natural sounds as mentioned above wherein an outer wall of the annular ring (10) has, at least a bump (20) to prevent the annular ring (10) from slipping away.

### BRIEF DESCRIPTION OF DRAWINGS OF THE INVENTION

FIG. 1: shows an exploded view of a conventional microphone.

FIG. 2: shows a perspective view of an acoustical grille of the first embodiment of the invention.

FIG. 3: shows a cross sectional view of the acoustical grille of the first embodiment of the invention.

FIGS. 4A, 4B: show schematic views of the acoustical grille of the first embodiment coupled to a microphone.

FIG. 5: shows a perspective view of the acoustical grille of the second embodiment of the invention.

FIG. 6: shows a cross sectional view of the acoustical grille of the second embodiment of the invention.

FIGS. 7A, 7B: show schematic views of the acoustical grille of the second embodiment coupled to a microphone.

FIG. 8: shows a perspective view of the acoustical grille of the third embodiment of the invention.

FIG. 9: shows a schematic view of FIG. 7

FIG. 10: shows a cross sectional view of the third embodiment

FIGS. 11A, 11B: show schematic views of the acoustical grille of the third embodiment of the invention coupled to a microphone.

FIG. 11C: shows a schematic view of taking out a grille ring from the acoustical grille.

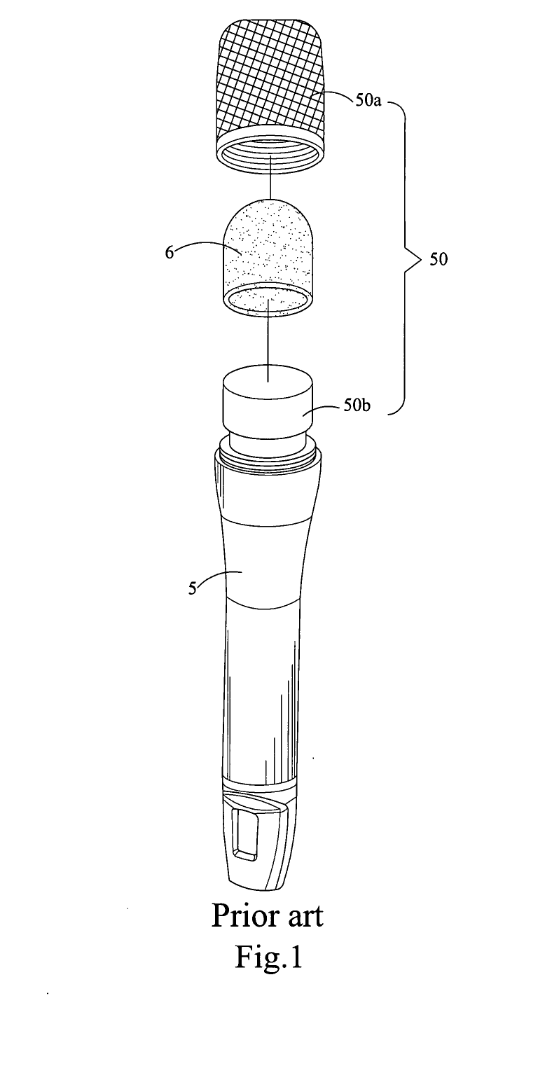

### DETAILED DESCRIPTION OF THE PREFERRE EMBODIMENTS OF THE INVENTION

Detailed description is described in detail according to the appended drawings hereinafter.

### First Embodiment

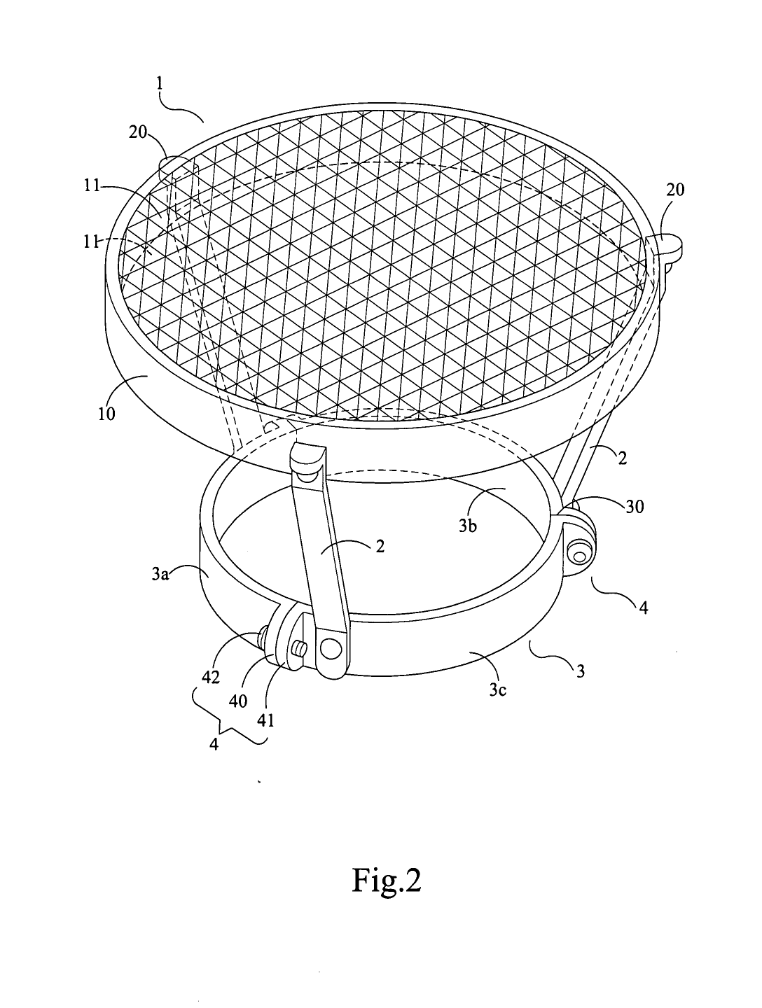

As shown in FIGS. 2˜4A, 4B, a microphone (5) equipped with an acoustical grille (1) free from spit moisture maintains frequency response to keep realistic and natural sounds, the acoustic grille (1) is secured to a receiver (50); a positioning ring (3) secured to the receiver (50); an annular ring (10) free from spit moisture having grilled shells (11) shielded over a top of the receiver (50); at least, a stand (2) connected between the annular ring (10) and the positioning ring (3), where the stand (2) is extended from the positioning ring (3) to the annular ring (10) as a support for the annular ring (10); a distance is kept between the grille shells (11) and the receiver (50). The acoustical grille (1) is shielded over the microphone (5) as the positioning ring (3) coupled to the receiver (50). Conversely, when the positioning ring (3) is detached from the receiver (50), the acoustical grille (1) is out of contact with the microphone (5). As a result, it is to facilitate the acoustical grille (1) replaces or cleans the grille shells (11); therefore, when the microphone is stored up for future use, the acoustical grille (1) is not necessary to put together with the microphone.

Further to facilitate a slip-proof performance, at least, a bump (20) is projected out from an outer wall of the annular ring (10) so as to prevent the annular ring (10) from slipping away where the microphone is placed onto. When an annular ring (10) and a positioning ring (3) are made of metal, the bump (20) is an extension of a distal end of a metal stand (3) connected to the positioning ring (10). Further, the bump (20) is extended in a direction substantially perpendicular to the outer wall of the annular ring (10). (as shown in FIG. 2) A bump (20) is able to restrain slippery of the microphone (5). So a bump (20) is to provide a safety mechanism to the microphone.

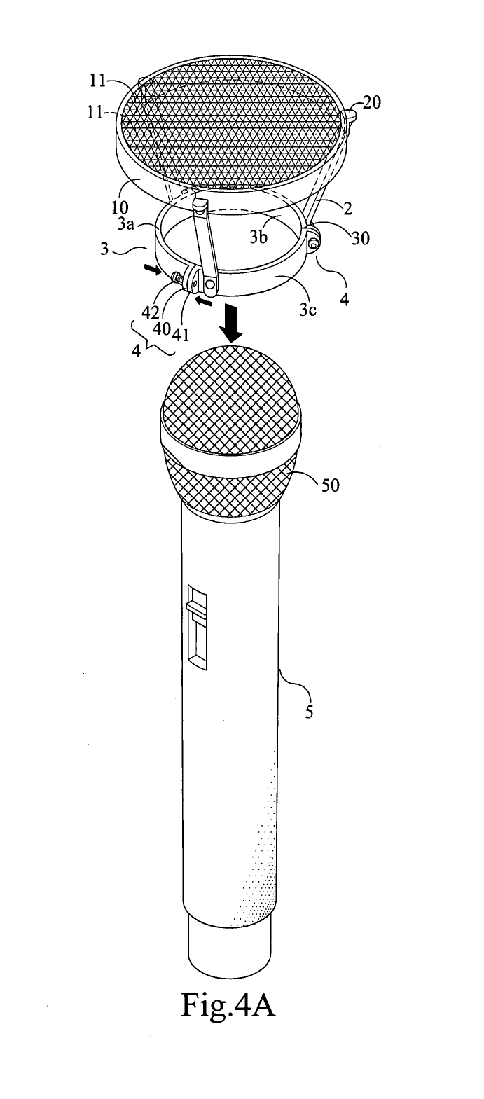

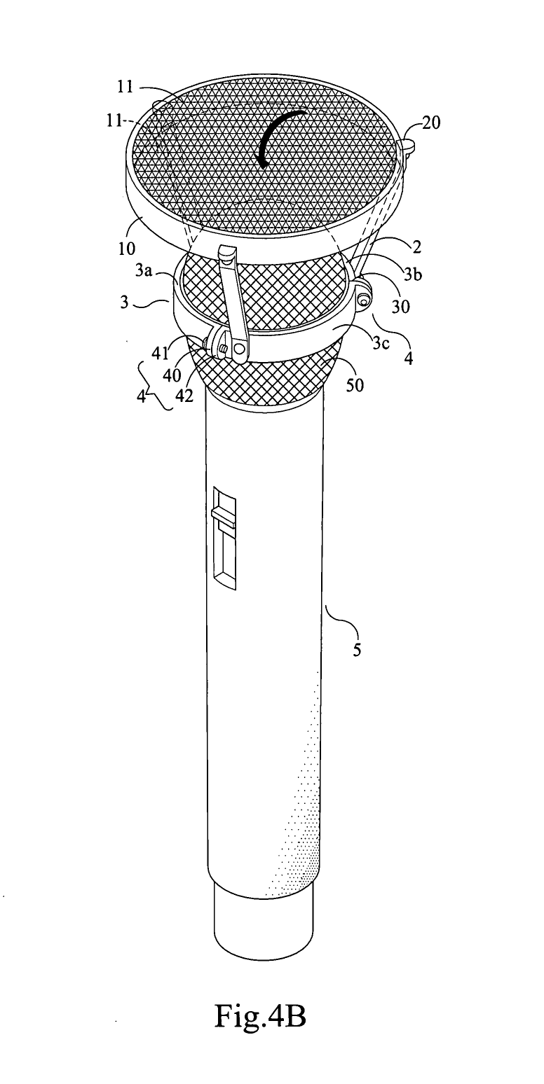

The positioning ring (3) has, at least, one crevice (30), as shown in FIG. 2, a positioning ring (3) consists of three identical curved ring portions (3a,3b,3c), thereby, three cervices (30) are equidistantly formed around the positioning ring (3). Each of the three crevices (30) has a bolt assembly (4) adapted to be inserted through the crevice (30) to restrict a width of the crevice (30) to adjust tightness/looseness between the positioning ring (3) and the receiver (50). The bolt assembly (40) is composed of a first bump (40) coupled to a first side of the crevice (30), a second bump (41) coupled to a second side of the crevice (30), and a threaded bolt (42) passed through the first bump (40) then screwed to a second bump (41) to adjust a distance kept between the bumps (40,41). When the threaded bolt (42) is rotated to thread through the crevice (30), the distance between the bumps (40, 41) can be adjusted as shown in FIG. 4A. Whereby, a diameter of the positioning ring (3) can be enlarged or shrunk. When the diameter is enlarged, the positioning ring (3) is removed from the receiver (50). Conversely, when the diameter is reduced, the receiver (50) is tied up in the positioning ring (3). As a result, the positioning ring (3) of the invention is adapted to hold most of the microphones receivers (50).

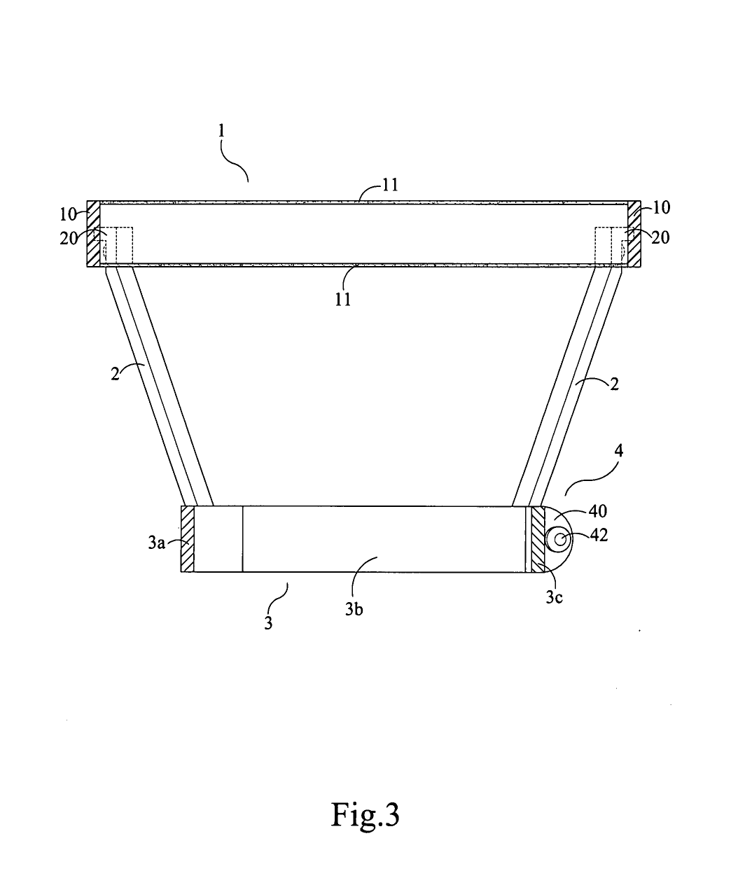

The grille shells (11) can be selectively made of nylon or non-woven fabric. As shown in FIGS. 4A and 4B, two grille shells (11) can be installed to a top side and a bottom side of the annular ring (10) respectively. Where the two grille shells (11) are not in contact with each other, a distance is kept in between. (as shown in FIG. 3) Thereby, the two grille shells (11) can be applied to prevent the microphone from sprayed by spit, dust etc., but a sound emission can be processed through the grille shells (11) of the microphone as shown in FIG. 4B. Further, confused or harsh sound emissions of users or breath sounds can be absorbed between the grille shells (10), thereby sounds picked up by the microphone demands for a higher pitch, where the original sounds can be tuned within higher vocal compass. It may be played at soft volume; the sounds are mellow and expressive.

Moreover, the stand (2) can be increased to two, three or more. As exemplified as shown in FIGS. 4A˜4B, three stands (2) are distributed in an equilateral triangular distribution likely a tripods (2) connected between the annular ring (10) and the positioning ring (3). Each stand (2) is joined together to one of curved ring portions (3a,3b,3c) of positioning ring (3) integrally.

### Second Embodiment

The second embodiment is different from the first embodiment, because the component of the first embodiment is made of metal, while in the second embodiment; the same is made from plastics.

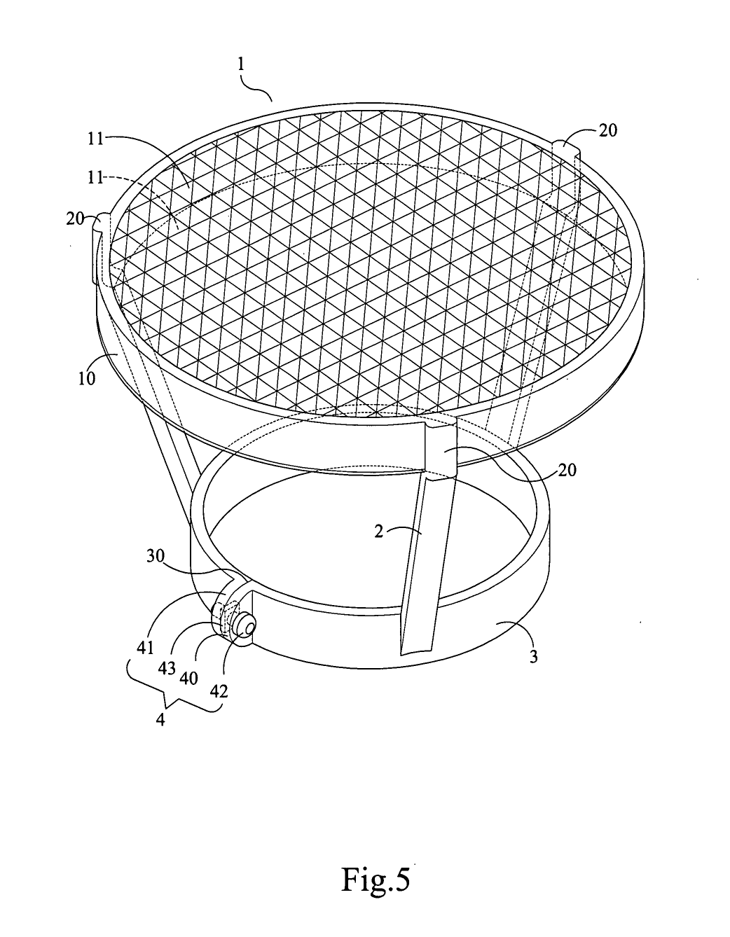

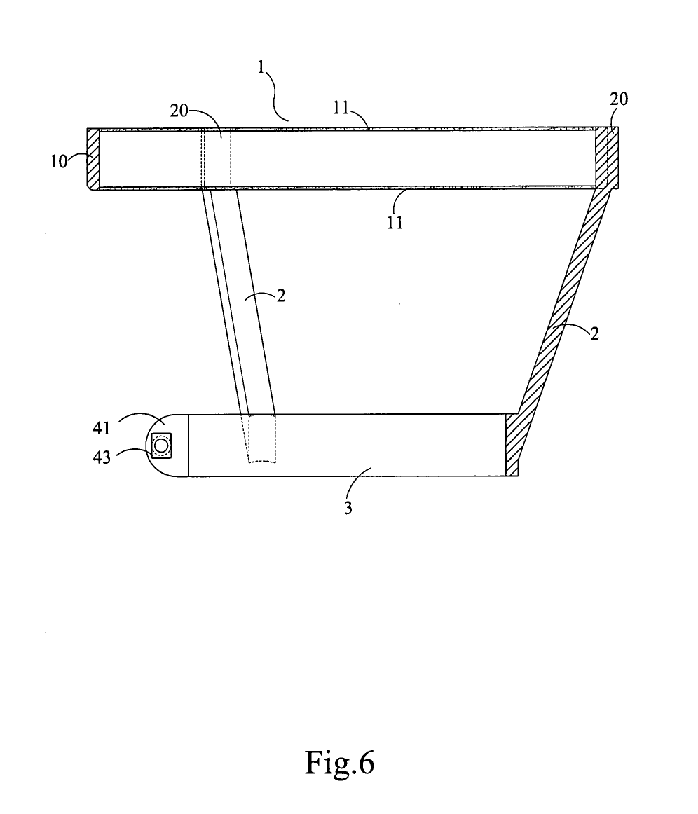

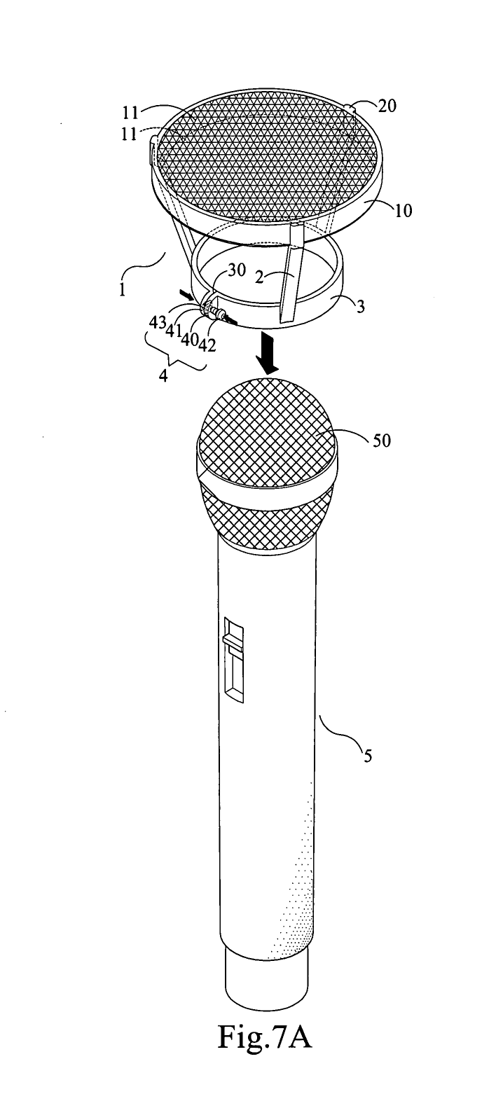

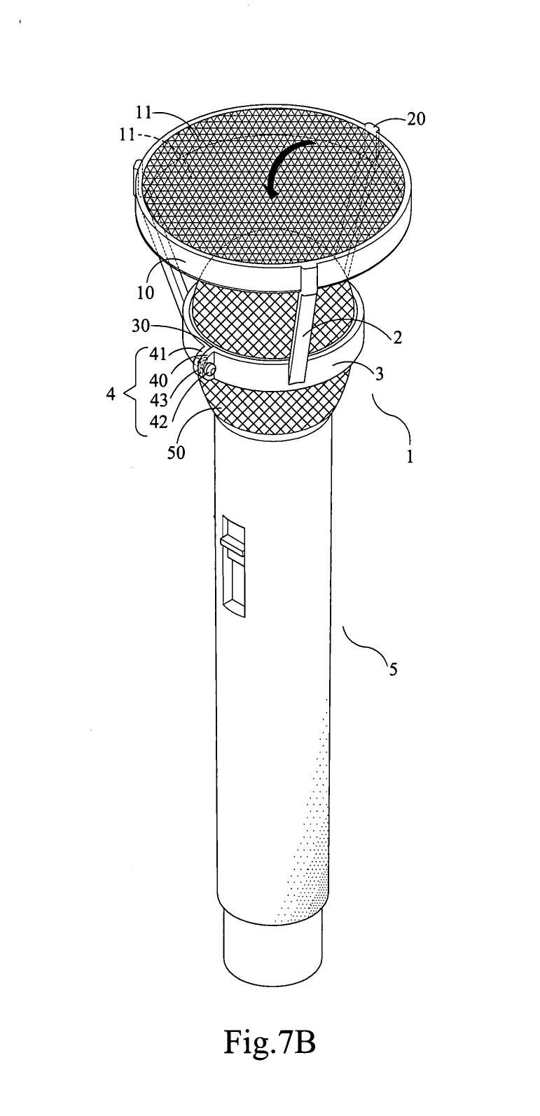

As shown in FIGS. 5˜7A, 7B, a positioning ring (3) and annular ring (10) are made from plastics; a bump (20) is projected out from an outer wall of the annular ring (10). Further the bump (20) extends in a direction perpendicular to the outer wall of the annular ring (10). (as shown in FIG. 4) But the bump (20) and a distal end of the stands (2) are not necessarily coincided. However, one or more bumps (20) can be projected out from anywhere of the outer wall of the annular ring (10).

Next, the positioning ring (3) has only one crevice (30), whereby the positioning ring (3) can be shaped as a C-shaped ring with only one crevice formed as an opening, a bolt assembly (4) adapted to be inserted through the crevice (30) to restrict a width of the crevice (30) to adjust tightness/looseness between the positioning ring (3) and the receiver (50); because the positioning ring (3) is mainly made from plastics, a metal plate (43) can be embedded into the crevice (30) as shown in FIG. 5, whereby the bolt (42) can be threaded through the metal plate (43). In practice, the crevice (30) contained metal plate (43) is to facilitate the threaded bolt (42) passed through the bump (40) to the bump (41) for adjusting a space in between. The metal plate (43) has a threaded hole (not shown) at a center to accommodate the bolt threaded through. To assemble and disassemble the positioning ring (3) and the receiver (50) in the second embodiment is, therefore, more prompt than the first embodiment.

### Third Embodiment

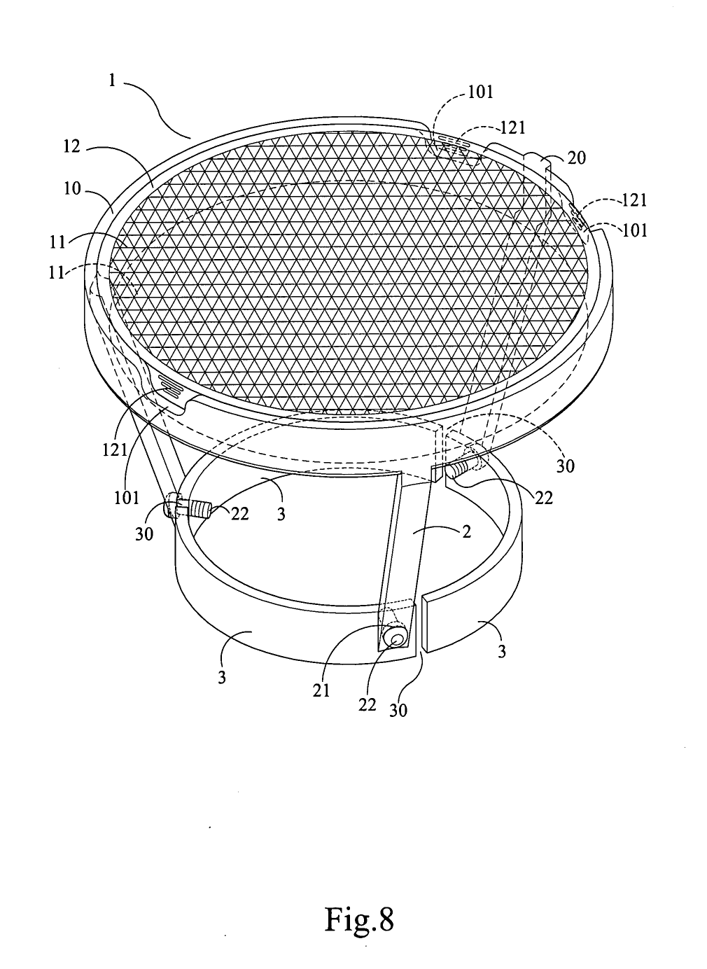

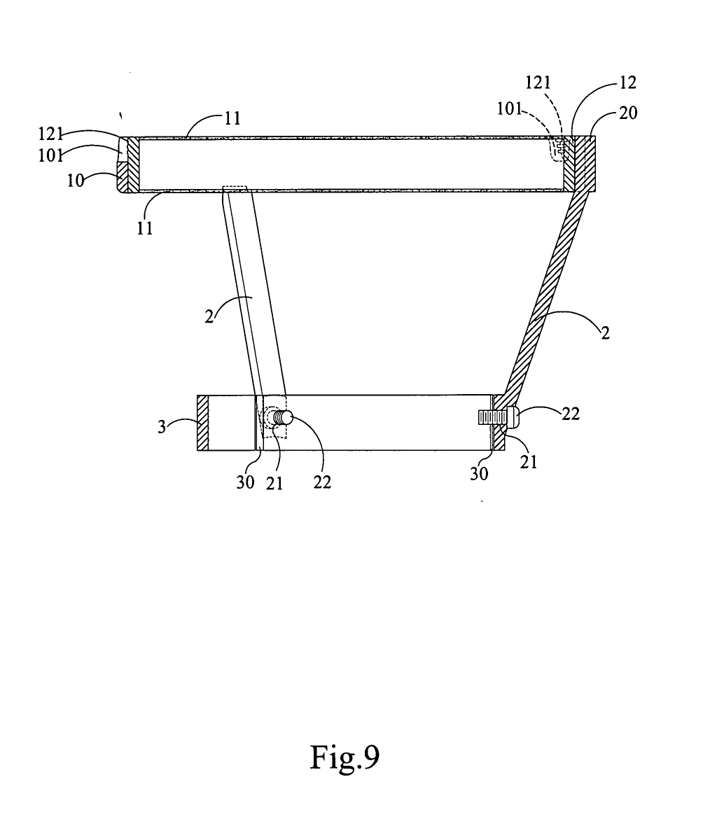

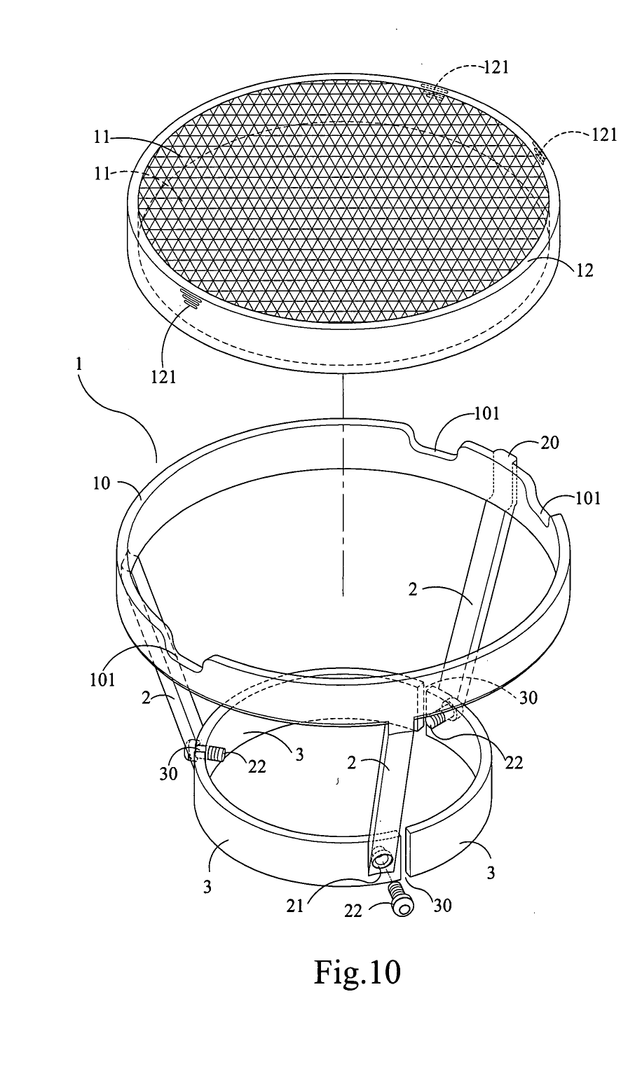

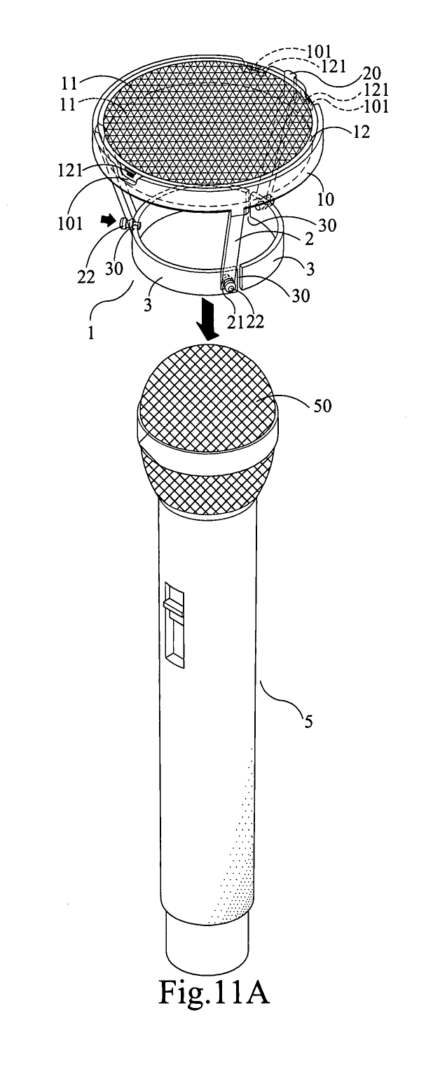

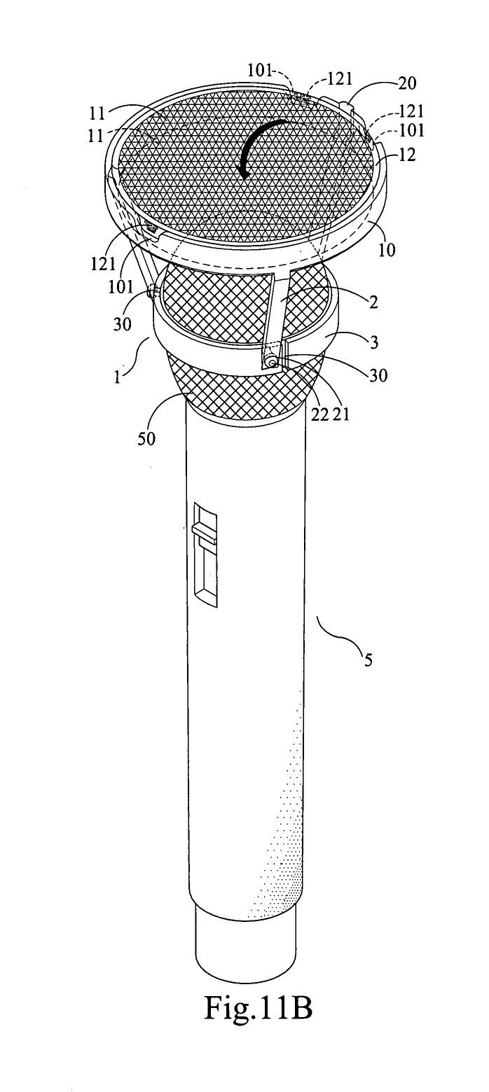

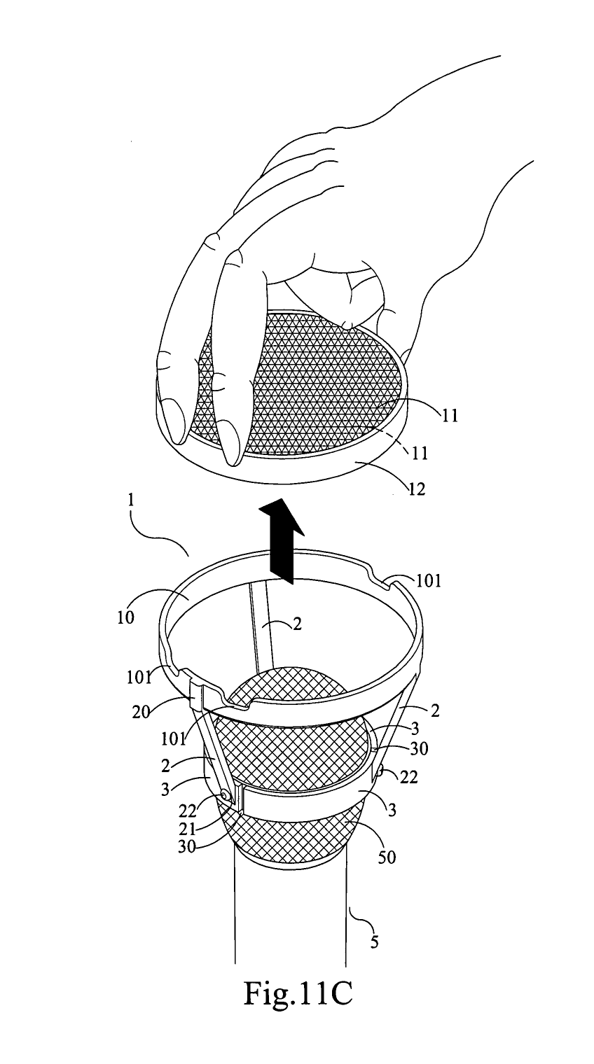

As shown in FIGS. 8˜11A, 11B, 11C, an acoustical grille (1) is secured to a receiver (50) of the microphone (5), a positioning ring (3) secured to the receiver (50); an annular ring (10) free from spit moisture is shielded over the receiver (50), a grille ring (12) having grille shells (11) is inlaid in the annular ring (10). At least, a stand (2) connected between an annular ring (10) and a positioning ring (3), a distance kept between the grille shells (11) and the receiver (50).

Three grooves (101) are arranged in an isosceles triangle arrangement formed around an outer wall of the annular ring (10), each of the three grooves with a number of corresponding forming slip-proof wrinkles (121) therein. Therefore it facilitates three fingers of the users in contact with the outer wall of a grille ring (12). The slip-proof wrinkles (121) can be clasped by fingers touch. As a result, the grille ring (12) can be taken off or inlaid in the annular ring (10) promptly. And the grille ring (12) is therefore easy to clean or replace.

There are two microphone grille shells (11) installed to the top and bottom sides of the grille ring (12), and a distance is kept between two grille shells (11). Because the grille shells (11) are already described in detail in the first embodiment, there is no more discussion about them.

Next, a positioning ring (3) has a threaded hole (21) and a crevice (30), the threaded hole (21) accommodates a screw (22) screwed in and resisted against microphone (5) receiver (50), or screw holes (not shown) of the receiver (50) default for the screw (22) screwed in to tie in the positioning ring (3) to the receiver (50).

### Advantage of Embodiments of the Invention

The present invention can be embodied to achieve the merits and advantages as following:

1. At least, one slip-proof bump is projected out from an outer wall of the annular ring (10), which is to be prevented from slipping away on an uneven surface, users can put it everywhere.

2. At least one grille shell (11) installed to a top or a bottom side of the annular ring (10) or a grille ring (12), but even both top and bottom sides are installed with grille shells (11), which will not in contact with each other. Confused or harsh sound emissions of users or breath sounds can be absorbed between the grille shells (10), thereby sounds picked up by the microphone demands for a higher pitch, where the original sounds can be tuned within higher vocal compass. It may be played at soft volume; the sounds are mellow and expressive.

3. A grille ring (12) can be disassembled from the annular ring (10), in addition, slip-proof wrinkles are correspondingly formed in grooves (101), which are formed in an isosceles triangle arrangement around the annular ring (10), thereby, fingers touch may be implemented to replace or clean the grille shells, further, in use, the grille shells made of different materials, such as nylon, non-woven fabric can be selected as desired.

4. The acoustical grille (1) can be separated from the microphone. It is easy carrying or exchanging without losing it. A positioning ring (3) is flexible to adapt to any types of microphones. Thus, the acoustical grille (1) of the invention instead of a conventional windscreen can avoid from dust-in or spit-in absorbed in chinks of foam.

1. A microphone (5) equipped with an acoustical grille (1) free from spit moisture extends original frequency response to keep realistic and natural sounds, the acoustical grille (1) secured to a top of a receiver (50) of microphone (5) characterized in that: a positioning ring (3) fit surround the receiver (50); an annular ring (10) free from spit moisture installed to a rim of the acoustical grille (1) with grille shells (11) shielded over the receiver (50); at least, a stand (2) connected between the annular ring (10) and positioning ring (3), whereby a distance kept between the grille shells (11) and the receiver (50).

2. A microphone (5) equipped with an acoustical grille (1) free from spit moisture extends original frequency response to keep realistic and natural sounds as claim 1 claimed wherein (1), an outer wall of the annular ring (10) is equipped with, at least a bump (20) to prevent an annular ring (10) from slipping away.

3. A microphone (5) equipped with an acoustical grille (1) free from spit moisture extends original frequency response to keep realistic and natural sounds as claim 1 claimed wherein the bump (20) is an extension of the stand (2) of the annular ring (10), the bump (20) is perpendicular to an outer wall of the annular ring (10).

4. A microphone (5) equipped with an acoustical grille (1) free from spit moisture extends original frequency response to keep realistic and natural sounds as claim 1 claimed wherein the positioning ring (3) has, at least, one clearance gap (30) adapted for bolt assembly (4) to adjust tightness/looseness between the positioning ring (3) and the receiver (50).

5. A microphone (5) equipped with an acoustical grille (1) free from spit moisture extends original frequency response to keep realistic and natural sounds as claim 1 claimed wherein the bolt assembly (4) consists of a first positioning bump (40) coupled to a first side of the clearance gap (30), a second positioning bump (41) coupled to a second side of the clearance gap (30), a threaded bolt (42) passed through the first positioning bump (40) then screwed to the second positioning bump (41).

6. A microphone (5) equipped with an acoustical grille (1) free from spit moisture extends original frequency response to keep realistic and natural sounds as claim 1 claimed wherein two grille shells (11) disposed to a top side and a bottom side of the annual ring (10) respectively, a distance kept between the two grille shells (11).

7. A microphone (5) equipped with an acoustical grille (1) free from spit moisture extends original frequency response to keep realistic and natural sounds, the acoustical grille (1) secured to a receiver (50) of the microphone (5), characterized in that: a positioning ring (3) secured to the receiver (50), an annular ring (10) shielded over a top of the receiver (50); a grille ring (12) with grille shells (11) inlaid in the annular ring (10); and, at least, a stand connected between the annular ring (10) and the positioning ring (3), a distance kept in betweens.

8. A microphone (5) equipped with an acoustical grille (1) free from spit moisture extends original frequency response to keep realistic and natural sounds as claim 7 claimed wherein a number of grooves (101) formed around the annular ring (10) to facilitate fingers touch.

9. A microphone (5) equipped with an acoustical grille (1) free from spit moisture extends original frequency response to keep realistic and natural sounds as claim 8 claimed wherein slip-proof wrinkles (121) formed around the annular ring corresponding to the grooves (101).

10. A microphone (5) equipped with an acoustical grille (1) free from spit moisture extends original frequency response to keep realistic and natural sounds as claim 7 claimed wherein two grille shells (11) disposed to a top side and a bottom side of the grille ring (12), a distance kept between the two grille shells (11).

11. A microphone (5) equipped with an acoustical grille (1) free from spit moisture extends original frequency response to keep realistic and natural sounds as claim 7 claimed wherein the positioning ring (3) has a clearance gap (30) and a threaded hole (21), the threaded hole (21) accommodates a screw (22) to screw therein.

12. A microphone (5) equipped with an acoustical grille (1) free from spit moisture extends original frequency response to keep realistic and natural sounds as claim 7 claimed wherein an outer wall of the annular ring (10) has, at least, a bump (20) to prevent the annular ring (10) from slipping away.
